(19) United States
(12) Patent Application Publication
(10) Pub. No.: US 2022/0053227 A1
(43) Pub. Date: Feb. 17, 2022

(54) VIDEO DISTRIBUTION SYSTEM, VIDEO DISTRIBUTION METHOD, AND VIDEO DISTRIBUTION PROGRAM

(71) Applicant: GREE, Inc., Tokyo (JP)

(72) Inventor: Aya KURABUCHI, Tokyo (JP)

(21) Appl. No.: 17/414,254

(22) PCT Filed: Nov. 7, 2019
(86) PCT No.: PCT/JP2019/043639

§ 371 Date: Jun. 15, 2021

(30) Foreign Application Priority Data
Dec. 18, 2018 (JP) 2018-236152
Jul. 1, 2019 (JP) 2019-122862

(51) Int. Cl. H04N 21/258; H04N 21/239; H04N 21/234

(52) U.S. Cl. CPC H04N 21/258; H04N 21/23418; H04N 21/239

(57) ABSTRACT

A video distribution system according to one embodiment of the invention includes one or more computer processors. The one or more computer processors execute computer-readable instructions to: in response to reception of a co-performing request for co-performing with a first user from a second user, determine whether to permit the second user's co-performing based on co-performing requester information related to the second user; generate a co-performing video in which the first user and the second user co-perform when the second user's co-performing is permitted; and distribute the co-performing video to one or more viewer users.

### TECHNICAL FIELD

The present disclosure relates to a video distribution system, a video distribution method, and a video distribution program. Specifically, the present disclosure relates to a system, method, and program, for live distributing a video containing a character object generated based on motion of a user.

### BACKGROUND

Video distribution systems that generate an animation of a character object based on motion of a distributor user and live distribute a video including the animation of the character object have been known. Such a video distribution system is disclosed, for example, in Japanese Patent Application Publication 2015-184689 (Patent Literature 1) and “Hasegawa Yusuke, Beginning of New Ear of Virtual Idle PROJECT Mari A, CG WORLD, Japan, Bone Digital Co., Ltd., Nov. 10, 2017, Vol. 231, pp. 74-79” (Non-Patent Literature 1).

A video distribution service for live distributing a video containing a character object generated based on motion of a distributor user is provided. As such a service, “Virtual Cast” provided by DWANGO Co., Ltd. is known. In Virtual Cast, a character object of a user is able to enter a video distributed by another distributor user, and the two distributor users can virtually appear together in the video through each character object.

### RELEVANT REFERENCES

### List of Relevant Patent Literature

Patent Literature 1: Japanese Patent Application Publication No. 2015-184689

Non-Patent Literature 1: Hasegawa Yusuke, Beginning of New Ear of Virtual Idle PROJECT Mari A, CG WORLD, Japan, Bone Digital Co., Ltd., Nov. 10, 2017, Vol. 231, pp. 74-79., Ltd., Nov. 10, 2017, Vol. 231, pp. 74-79.”

Non-Patent Literature 2: DWANGO Co., Ltd. Virtual Cast, “About Totsu,” [online], [retrieved on Nov. 25, 2018], Internet <URL: https://qa.nicovideo.jp/faq/show/10740?back=front%2Fcategory%3Ashow& category_id=718&page=1&site_domain=default&sort=sort_access& sort_order=desc>

### SUMMARY

In order to maintain the quality of a video that a distributor user distributes, what kind of user is a co-performer is of a great concern to the distributor user. However, unlike the cases where performers gather in a studio and co-perform in the real world, it is difficult to grasp the personality of the co-performer, which is another distributor user who virtually co-performs with the distributor user through a character object. If a co-performing request from another user to the distributor user is automatically accepted and approved or judgment of the approval is left to the distributor user, there is a risk that the co-performer can be a person who behaves undesirably in the distribution video. Especially when the co-performance is performed through their character objects in the video, it may be difficult to stop undesired actions by the co-performer because of its anonymity.

As described above, when two or more distributor users virtually co-perform together in a video via their character objects, it is desirable to properly select the co-performing partners in order to ensure the quality of the video being distributed. However, unlike in the real world, it is difficult to predict whether the co-performer behaves in a desirable manner before the distribution of the video.

It is an object of the present disclosure to provide a technical improvement which solves or alleviates at least part of the drawbacks of the prior art mentioned above. Specifically, one object of the disclosure is to provide a system, method, and a program for video distribution in which co-performers who virtually perform in a video can be screened and selected.

According to one aspect of the invention, a video distribution system includes one or more computer processors. In one embodiment, the one or more computer processors execute computer-readable instructions to: in response to reception of a co-performing request for co-performing with a first user from a second user, determine whether to permit the second user's co-performing based on co-performing requester information related to the second user; generate a co-performing video in which the first user and the second user co-perform when the second user's co-performing is permitted; and distribute the co-performing video to one or more viewer users. The determination whether to permit the co-performing may be performed based on co-performing requester information related to the first user.

In one embodiment, the co-performing video is a character co-performing video including a first character object generated based on motion of the first user and a second character object generated based on motion of the second user; In another embodiment, the co-performing video is a voice co-performing video including voice of the second user and a first character object generated based on motion of the first user. The character co-performing video and the voice co-performing video may be alternately switchable.

In one embodiment, the co-performing requester information includes user evaluation information indicating an evaluation of the second user.

In one embodiment, the co-performing requester information includes video evaluation information indicating an evaluation of a video distributed by the second user.

In one embodiment, the co-performing requester information includes a video distribution time or the number of video distributions of the second user.

In one embodiment, the co-performing requester information includes co-performing ban information identifying a user that the second user is banned from co-performing with.

In the video distribution system according to one embodiment, when it is determined that a second character object is in an inactive state in the co-performing video based on motion data indicating motion of the second user, the second character object is excluded from the co-performing video.

In the video distribution system according to one embodiment, the second character object is excluded from the co-performing video based on co-performer evaluation information indicating an evaluation of the second user from the one or more viewer users during distribution of the co-performing video.

In the video distribution system according to one embodiment, the second character object is excluded from the co-performing video in response to a request from the first user.

Another aspect of the invention relates to a method of distributing a video performed by executing computer readable instructions by one or more computer processor. The method includes: in response to reception of a co-performing request for co-performing with a first user from a second user, determining whether to permit the second user's co-performing based on a co-performing requester information related to the first user or the second user; generating a co-performing video in which the first user and the second user co-perform when the second user's co-performing is permitted; and distributing the co-performing video to one or more viewer users.

Yet another aspect of the invention relates to a video distribution program. The video distribution program causing one or more computer processors to: in response to reception of a co-performing request for co-performing with a first user from a second user, determining whether to permit the second user's co-performing based on a co-performing requester information related to the first user or the second user; generate a co-performing video in which the first user and the second user co-perform when the second user's co-performing is permitted; and distribute the co-performing video to one or more viewer users.

### ADVANTAGEOUS EFFECTS

According to the aspects of the invention, it is possible to screen co-performer(s) who virtually co-perform in a video.

### BRIEF DESCRIPTION OF THE DRAWINGS

FIG. 1 is a block diagram illustrating a video distribution system in one embodiment.

FIG. 2 schematically illustrates a distributor user who distributes a video in the video distribution system of FIG. 1 and a distributor user device that the distributor user uses.

FIG. 3 is an explanatory drawing for co-performing requester information stored in the video distribution system of FIG. 1.

FIG. 4 is an explanatory drawing for co-performing video information stored in the video distribution system of FIG. 1.

FIG. 5 illustrates an example of a view on the screen of the viewer user device 10 in one embodiment.

FIG. 6A illustrates an example of a view on a screen of a distributor user device 20a in one embodiment.

FIG. 6B illustrates an example of a view on a screen of a distributor user device 20b in one embodiment.

FIG. 7 illustrates an example of a view of the co-performing video displayed on the viewer user device 10 in one embodiment.

FIG. 8A illustrates an example of a view of the co-performing video displayed on the distributor user device 20a in one embodiment.

FIG. 8B illustrates an example of a view of the co-performing video displayed on the distributor user device 20b in one embodiment.

FIG. 9 is a flow chart showing flow of a video distribution process in one embodiment.

FIG. 10 is a flow chart showing flow of a process of distributing a co-performing video in one embodiment.

### DESCRIPTION OF THE EMBODIMENTS

Various embodiments of the disclosure will be described hereinafter with reference to the accompanying drawings. Throughout the drawings, the same or similar elements are denoted by the same reference numerals.

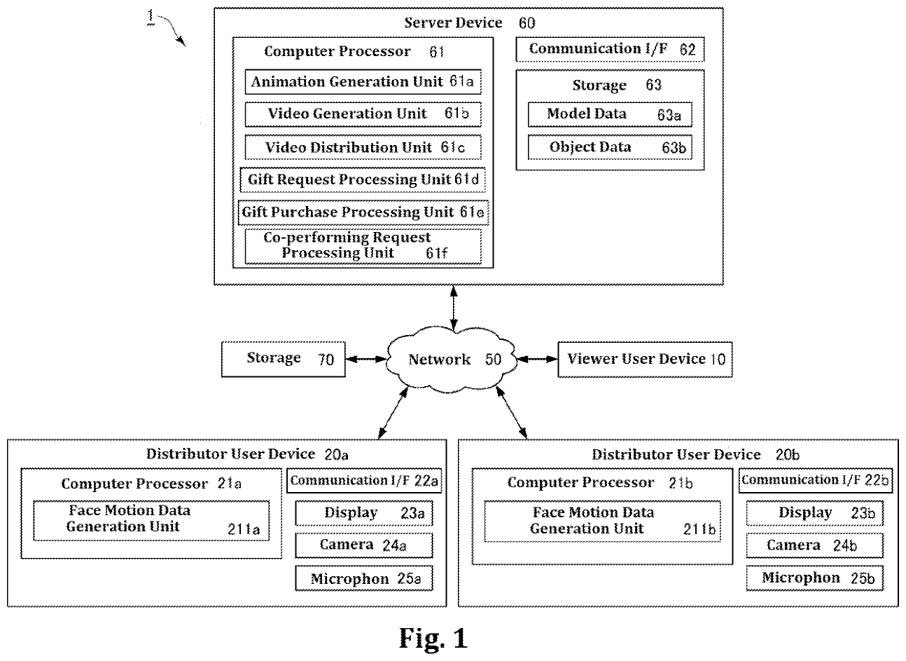

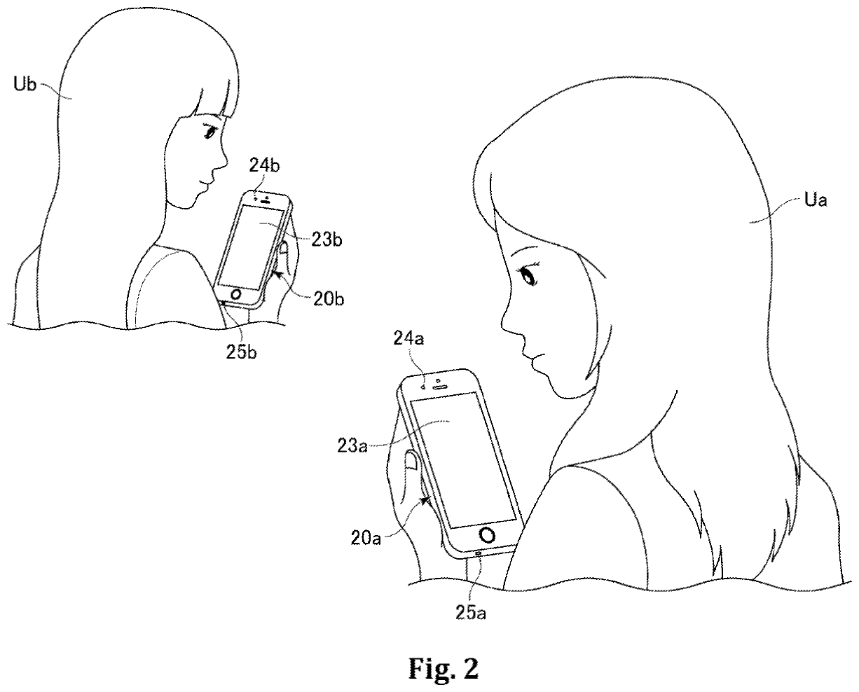

With reference to FIGS. 1 to 2, a video distribution system in one embodiment will be described. FIG. 1 is a block diagram illustrating a video distribution system 1 in one embodiment, and FIG. 2 schematically illustrates distributor users Ua and Ub who distribute a video in the video distribution system of FIG. 1 and distributor user devices 20a and 20b that the distributor users Ua and Ub use. The distributor user device 20a has a feature for distributing a video that includes a character object generated based on motion of the user Ua in the video distribution system 1, and the distributor user device 20b has a feature for distributing a video that includes a character object generated based on motion of the user Ub in the video distribution system 1. As will be described in detail later, the video distribution system 1 is capable of generating a video that includes character objects of two or more distributor users and distributing the video. That is, in the video distribution system 1, two or more distributor users are able to virtually co-perform in a video via their character objects. Thus, when two or more distributor users virtually co-perform in a video via their respective character objects, the video is herein referred to as a co-performing video. For example, when a video including a character object generated based on motion of the user Ub is being distributed, the user Ua is able to make a request for co-performing with the user Ub in the video. When this co-performing request is approved, a co-performing video including the character object of the user Ub and the character object of the user Ua is generated, and the co-performing video is distributed. The distributor user devices 20a and 20b may each have a viewing feature to view a video distributed by the video distribution system 1.

The video distribution system 1 includes a viewer user device 10, the distributor user device 20a and 20b, a server device 60, and a storage 70. The viewer user device 10, the distributor user device 20, the server device 60, and the storage 70 are communicably interconnected over a network 50. The server device 60 is configured to distribute a video including animations of characters of the distributor users Ua and Ub as described later. In addition to the video distribution service, the server device 60 may also provide a social networking services for users to interact with each other or platform functions for such services.

In the video distribution system 1, the video is distributed from the server device 60 to the viewer user device 10 and the distributor user devices 20a and 20b. The distributed video is displayed on a display of the viewer user device 10. A viewer user who is a user of the viewer user device 10 is able to view the distributed video on the viewer user device. Although only the single viewer user device 10 is shown in FIG. 1 to simplify the drawing, the video distribution system 1 may include two or more viewer user devices. The distributor users Ua and Ub are able to perform while checking moving images in the video by viewing the distributed video. In addition, the distributor users Ua and Ub are also able to view a video that includes character objects of other users on the respective distributor user devices 20a and 20b.

In the illustrated embodiment, the distributor user device 20a includes a computer processor 21a, a communication I/F 22a, a display 23a, a camera 24a, and a microphone 25a. Similarly, the distributor user device 20b includes a computer processor 21b, a communication I/F 22b, a display 23b, a camera 24b, and a microphone 25b. Since the distributor user device 20a and the distributor user device 20b have similar configurations and functions, they may be referred to collectively as the distributor user device 20 when there is no particular need to distinguish between them, and their components may also be collectively referred to as, for example, the computer processor 21, etc.

The computer processor 21 is a computing device which loads various programs realizing an operating system and various functions from the storage into a memory unit and executes instructions included in the loaded programs. The computer processor 21 is, for example, a CPU, an MPU, a DSP, a GPU, any other computing device, or a combination thereof. The computer processor 21 may be realized by means of an integrated circuit such as ASIC, PLD, FPGA, MCU, or the like. Although the computer processor 21 is illustrated as a single component in FIG. 1, the computer processor 21 may be a collection of a plurality of physically separate computer processors.

The communication I/F 22 may be implemented as hardware, firmware, or communication software such as a TCP/IP driver or a PPP driver, or a combination thereof. The distributor user device 20 is able to transmit and receive data to and from other devices via the communication I/F 22.

The display 23 includes a display panel and a touch-screen panel. The touch-screen panel is configured to detect touch interactions (touch operations) performed by a user. The touch-screen panel is capable of detecting various touch operations such as tapping, double tapping, and dragging performed by the user. The touch-screen panel may include a capacitive proximity sensor and may be capable of detecting a non-contact operation performed by the user.

The camera 24 continuously captures images of faces of the distributor users Ua and Ub to obtain imaging data of the faces of the distributor users Ua and Ub. The imaging data of the faces of the distributor users Ua and Ub captured by the camera 24 is transmitted to the server device 60 via the communication I/F 22. The the camera 24 may be 3D cameras capable of detecting the depth of a face of a person.

The microphone 25 is a sound collector configured to convert voice inputted thereto into voice data. The microphone 25 is capable of obtaining a voice input of the distributor users Ua and Ub. The voice input of the distributor users Ua, Ub obtained by the microphone 25 is converted into voice data, and the voice data is transmitted to the server device 60 via the communication I/F 22.

The viewer user device 10 may include the same components as the distributor user device 20. For example, the viewer user device 10 may include a computer processor, a communication I/F, a display, and a camera. The viewer user device 10 may perform the same functions as the distributor user device 20 by downloading and installing a prescribed application software.

The viewer user device 10 and the distributor user device 20 are information processing devices such as smartphones. In addition to the smartphones, the viewer user device 10 and the distributor user device 20 may be mobile phones, tablets, personal computers, electronic book readers, wearable computers, game consoles, or any other information processing devices that are capable of reproducing a video. The viewer user device 10 and the distributor user device 20 may each include a sensor unit including various sensors such as a gyro sensor and a storage for storing various information in addition to the above-mentioned components.

Next, a description is given of the server device 60. In the illustrated embodiment, the server device 60 includes a computer processor 61, a communication I/F 62, and a storage 63.

The computer processor 61 is a computing device which loads various programs realizing an operating system and various functions from the storage 63 or other storage into a memory unit and executes instructions included in the loaded programs. The computer processor 61 is, for example, a CPU, an MPU, a DSP, a GPU, any other computing device, or a combination thereof. The computer processor 61 may be realized by means of an integrated circuit such as ASIC, PLD, FPGA, MCU, or the like. Although the computer processor 61 is illustrated as a single component in FIG. 1, the computer processor 61 may be a collection of a plurality of physically separate computer processors.

The communication I/F 62 may be implemented as hardware, firmware, or communication software such as a TCP/IP driver or a PPP driver, or a combination thereof. The server device 60 is able to transmit and receive data to and from other devices via the communication I/F 62.

The storage 63 is a storage device accessed by the computer processor 61. The storage 63 is, for example, a magnetic disk, an optical disk, a semiconductor memory, or various other storage devices capable of storing data. Various programs may be stored in the storage 63. At least some of the programs and various data that may be stored in the storage 63 may be stored in a storage (for example, a storage 70) that is physically separated from the server device 60.

In this specification, a program or instructions included in the program that are described as being executed by the computer processor 21 or the computer processor 61 may be executed by a single computer processor or executed by a plurality of computer processors distributively. Further, a program or instructions included in the program executed by the computer processor 21 or the computer processor 61 may be executed by a plurality of virtual computer processors.

Next, data stored in the storage 63 will be described. In the illustrated embodiment, the storage 63 stores model data 63a, object data 63b, co-performing requester information 63c, co-performing video information 63d, and any other data required for generation and distribution of a video to be distributed.

The model data 63a is model data for generating animation of a character. The model data 63a may be three-dimensional model data for generating three-dimensional animation, or may be two-dimensional model data for generating two-dimensional animation. The model data 23a includes, for example, rig data (also referred to as “skeleton data”) indicating a skeleton of a face and a skeleton of body parts other than the face of a character, and surface data indicating the shape or texture of surfaces of the character. The model data 63a may include two or more different pieces of model data. The pieces of model data may each have different rig data, or may have the same rig data. The pieces of model data may have different surface data or may have the same surface data.

The object data 63b includes asset data used for constructing a virtual space in the video. The object data 63b includes data for rendering a background of the virtual space in the video, data for rendering various objects displayed in the video, and data for rendering any other objects displayed in the video. The object data 63b may include object position information indicating the position of an object in the virtual space.

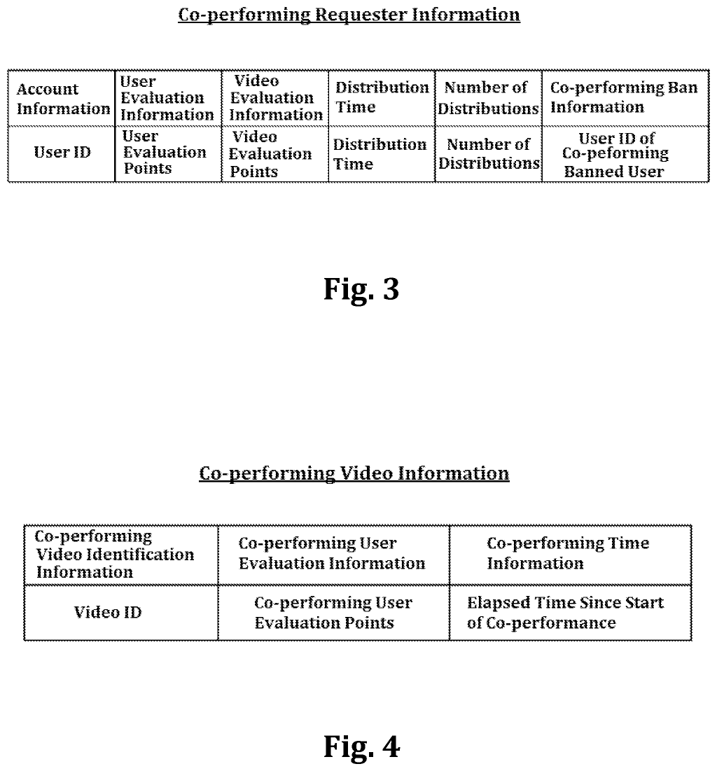

An example of the co-performing requester information 63c is shown in FIG. 3. As shown in FIG. 3, various data related to a user are stored as the co-performing requester information 63c in association with the account information of the user who uses the video distribution system 1. As will be described later, when a user makes a co-performing request for co-performance with another user, the co-performing requester information 63c may be referred in order to determine whether to approve the request. The co-performing requester information 63c of a user may include user evaluation information indicating an evaluation of the user, video evaluation information indicating an evaluation on a video distributed by the user, a distribution time indicating the number of hours or minutes the user distributed videos, the number of times that the user distributed the videos, and co-performing ban information indicating a user(s) who is banned from co-performing with the user. The co-performing requester information 63c may include information other than the above.

The account information of a user is, for example, user identification information (user ID) that identifies the user. The user ID is assigned to a user when the user first signs up for the video delivery system 1 to use the service.

The user evaluation information, which is associated with the account information of the user, is information indicating evaluations on the user made by other users. The user evaluation information is, for example, user evaluation points represented by a natural number. The user of the video delivery system 1 is able to distribute a video containing his/her character object via the server device 60. The user evaluation points of a user may be updated based on feedbacks from viewers of the video distributed by the user. For example, feedbacks from viewer users may include selection of a “like” button displayed on a viewing screen, selection of a “boo” button for negative feedback, gifting (sending gift) items displayed on the viewing screen, sending comments from the viewing screen, and any other feedbacks. The “like” button is supposed to be selected when a viewer has a favorable impression of the video that the viewer is watching or a distributor user who is distributing the video. The “like” button may be displayed on the viewing screen as an icon that contains the word “awesome” or “like. The “boo” button is supposed to be selected when the viewer has a negative impression, such as distaste, of the video that the viewer is watching or the distributor user who distributes the video. The “boo” button may be displayed on the viewing screen as an icon that contains the word “not good” or “dislike,” which indicate distaste. Such a button and icon for expressing favorable feelings may be herein referred to as a “favorable button” and “favorable icon” respectively, and a button and icon for expressing distaste may be referred to as an “unfavorable button” and “unfavorable icon” respectively. The evaluation points may include the number of times the favorable button is selected, the number of times the unfavorable button is selected, the number of times gifting is performed (or the total amount of money spent for gifting), the number of comments, or any other parameter related to feedbacks from the viewer users. For example, the user evaluation points may be increased when a positive or negative feedback is given by a viewer user. The user evaluation points may be counted based on the number or amount of positive feedbacks from the viewer users or the number or amount of negative feedbacks from the viewer users. Alternatively, the user evaluation points may be increased or decreased depending on the number of positive and negative feedbacks respectively. More specifically, the user evaluation points may be increased when a positive feedback is given and decreased when a negative feedback is given, or vice versa. The user evaluation points of a user may be updated at any time other than such a feedback on the video distributed by that user. For example, when one user interacts with other users using a social networking service provided by the server device 60, the user evaluation points may be updated based on an activity using the social networking service.

The video evaluation information, which is associated with the account information of the user, is information indicating evaluations made by other users on the video that the user distributed. The video evaluation information is, for example, video evaluation points represented by a natural number. The video evaluation points of a user may be updated based on feedbacks from viewers of the video distributed by the user. For example, the video evaluation points may be increased when a positive or negative feedback is given by a viewer user who watched the video. When a feedback is given for a video distributed by a user, both the user evaluation points and video evaluation points may be updated.

The distribution time associated with the account information of a user is the number of hours or minutes the user has distributed videos. The distribution time may be the total number of hours or minutes from the start of using the video delivery system 1, or may be the number of hours or minutes the user distributed videos in a certain period of time. The number of distributions associated with the user's account information is the number of times that the user distributed videos. The number of distributions may be the total number of times since the start of using the video delivery system 1, or it may be the distribution frequency in a certain period of time.

The co-performing ban information associated with the account information of one user is users ID of other users who have designated the user as a banned user prohibited from co-performing with them. In the video distribution system 1, one user may designate one or more other users with whom the user will not co-perform. For example, a user A may designate a user B, who seems likely to behave undesirably in a video that the user A distributes, as the co-performance banned user. In this case, the user ID of the user A is stored as the co-performing ban information in association with the user ID of the user B. When the user A designates the user B as the co-performance banned user, the user ID of the user B may be stored in association with the user ID of the user A as the co-performing ban information.

An example of the co-performing video information is shown in FIG. 4. As shown in FIG. 4, various data related to a co-performing video is stored as the co-performing video information 63d in association with co-performing video identification information that identifies the co-performing video. The co-performing video information 63d for a co-performing video may include co-performing user evaluation information indicating the evaluation of the co-performing user in the co-performing video and co-performance time information indicating the elapsed time since the start of the co-performance in the co-performing video.

When one user makes a request for co-performing with another user, the co-performing request is approved, and the co-performing video is distributed, the user who made the co-performing request may be herein referred to as a “co-performing user”. The user who is originally distributing the video and received the co-performance request may be referred to as a “host user”. The co-performing user information indicates the evaluation of the co-performing user, not the host user. The co-performing user evaluation information of a co-performing user is, for example, co-performing user evaluation points represented by a natural number.

The co-performance time information indicates the elapsed time since the start of the co-performance of the co-performing user and the host user.

The distributor user device 20 may realize a function other than the face motion data generation unit 211a by executing the distribution program and/or any other program on the computer processor. For example, the distributor user device 20 may realize a playing back function for playing a received video by executing a viewing program for watching a video. The distribution program and the viewing program may be packaged as a single application software, or may be provided as separate application software.

The viewer user device 10 may be configured to provide the same functions as the distributor user device 20. For example, the viewer user device 10 may realize the playing back function for playing a received video by executing the viewing program for watching a video, and may realize function similar to the function of the face motion data generation unit 211a by executing the distribution program.

Functions realized by the computer processors 21a and 21b will be now described more specifically. The computer processor 21a functions as a face motion data generation unit 211a by executing computer-readable instructions included in a distribution program. Similarly, the computer processor 21b functions as a face motion data generation unit 211b by executing computer-readable instructions included in a distribution program. At least some of the functions that can be realized by the computer processors 21a, 21b may be realized by a computer processor other than the computer processors 21a, 21b of the video distribution system 1. For example, at least some of the functions realized by the computer processors 21a, 21b may be realized by the computer processor 61 mounted on the server device 60.

The face motion data generation unit 211a generates face motion data, which is a digital representation of motion of the face of the distributor user U1a, based on captured image data of the camera 24a. Similarly, the face motion data generation unit 211b generates face motion data, which is a digital representation of motion of the face of the distributor user Ub, based on captured image data of the camera 24b. The face motion data is serially generated with time as needed. The face motion data may be generated at predetermined sampling time intervals. Thus, the face motion data generated by the face motion data generation unit 211a can digitally represent facial motion (changes in facial expression) of the distributor user Ua, and the face motion data generated by the face motion data generation unit 211b can digitally represent facial motion (changes in facial expression) of the distributor user Ub. The face motion data generated by the face motion data generation unit 211a, 211b is transmitted to the server device 60 via the communication I/Fs 22a, 22b.

In addition to the face motion data generated by the face motion data generation unit 211a, the distributor user device 20 may generate body motion data that is a digital representation of the position and orientation of any body part other than the faces of the distributor users Ua, Ub. The distributor user device 20 may transmit the body motion data to the server device 60 in addition to the face motion data. In order to generate the body motion data, the distributor users Ua and Ub may each wear a motion sensor. The distributor user device 20 may be capable of generating the body motion data based on detection result information of the motion sensors attached to the distributor users Ua and Ub. The body motion data may be generated at predetermined sampling time intervals. Thus, the body motion data can represent body motion of the distributor users Ua and Ub in time series as digital data. Generation of the body motion data based on the detection result information of the motion sensors attached to the distributor users Ua and Ub may be performed, for example, in a shooting studio. The shooting studio may be provided with a base station, a tracking sensor, and a display. The base station may be a multi-axis laser emitter. The motion sensors attached to the distributor users Ua and Ub may be, for example, Vive Trackers provided by HTC CORPORATION. The base station installed in the shooting studio may be, for example, a base station provided by HTC CORPORATION. In addition, a supporter computer may be provided in a separate room from the shooting studio. The display in the shooting studio may be configured to display information received from the support computer. The server device 60 may be installed in the same room as the room in which the supporter computer is installed. The room where the support computer is installed and the shooting studio may be separated by a glass window. In this case, an operator of the supporter computer (may also be herein referred to as a “supporter”) can see the distributor users Ua, Ub. The supporter computer may be capable of changing the setting(s) of the devices installed in the shooting studio according to the operation by the supporter. The supporter computer can change, for example, the setting of a scanning interval performed by the base station, the setting of of the tracking sensor, and various settings of other devices. The supporter is able to input a message to the supporter computer, and the inputted message is displayed on the display in the shooting studio.

Functions realized by the computer processor 61 will be now described more specifically. The computer processor 61 functions as an animation generation unit 61a, a video generation unit 61b, a video distribution unit 61c, a co-performance request determination unit 61d, co-performing request processing unit 61e, and a co-performing termination processing unit 61f by executing computer-readable instructions included in the distribution program.

The animation generation unit 61a is configured to apply a face motion data generated by the face motion data generation unit 21a in the distributor user device 20 to predetermined model data included in the model data 63a in order to generate an animation of a character object. The animation generation unit 61a is capable of generating an animation of a character object such that the expression of the character object changes based on the face motion data. More specifically, the animation generation unit 61a is capable of generating an animation of a character object whose face moves in synchronization with the facial expression of the distributor user Ua based on the face motion data related to the distributor user Ua. Similarly, the animation generation unit 61a is capable of generating an animation of a character object whose face moves in synchronization with the facial expression of the distributor user Ub based on the face motion data related to the distributor user Ub.

When the distributor user device 20 provides body motion data of the distributor users Ua and Ub, the animation generation unit 61a is capable of generating animations of character objects whose bodies and faces move in synchronization with the body motion and the facial expressions of the distributor users Ua and Ub based on the body motion data and the face motion data related to the distributor users Ua and Ub.

When a video of the distributor user Ua is distributed, the video generation unit 61b may generate a background image representing a background using the object data 63b, and may generate a video including the background image and an animation of a character object corresponding to the distributor user Ua. The video generation unit 61b is capable of adding voice of the distributor user Ua produced based on the voice data received from the distributor user device 20a to the generated video. Similarly, when a video of the distributor user Ub is distributed, the video generation unit 61b may generate a background image representing a background using the object data 63b, and may generate a video including the background image and an animation of a character object corresponding to the distributor user Ub. The video generation unit 61b may add voice of the distributor user Ub produced based on the voice data received from the distributor user device 20b to the generated video. In the videos generated by the video generation unit 61b, the character objects corresponding to the distributor users Ua and Ub are displayed such that they are superimposed on the background images. As described above, the video generation unit 61b generates the animation of the character object moving in synchronization with the facial expression of the distributor user Ua or Ub, and generates the video in which the voice of the distributor user Ua or Ub is added to the animation for distribution.

The video distribution unit 61c distributes the video generated by the video generation unit 61b. The video is distributed to the viewer user device 10 and other viewer user devices over the network 50. The generated video is also distributed to the distributor user devices 20a and 20b. The distributed video is played on the viewer user device 10 and the distributor user devices 20a and 20b. The video distribution unit 61c may monitor, for each distributor user, the distribution time or the number of distributions or both. The video distribution unit 61c may update the distribution time and the number of distributions in the co-performing requester information based on the monitoring results.

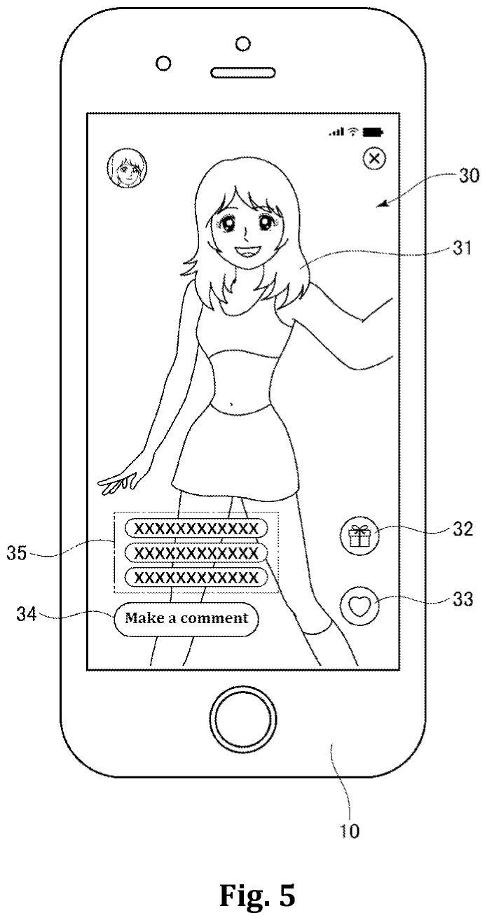

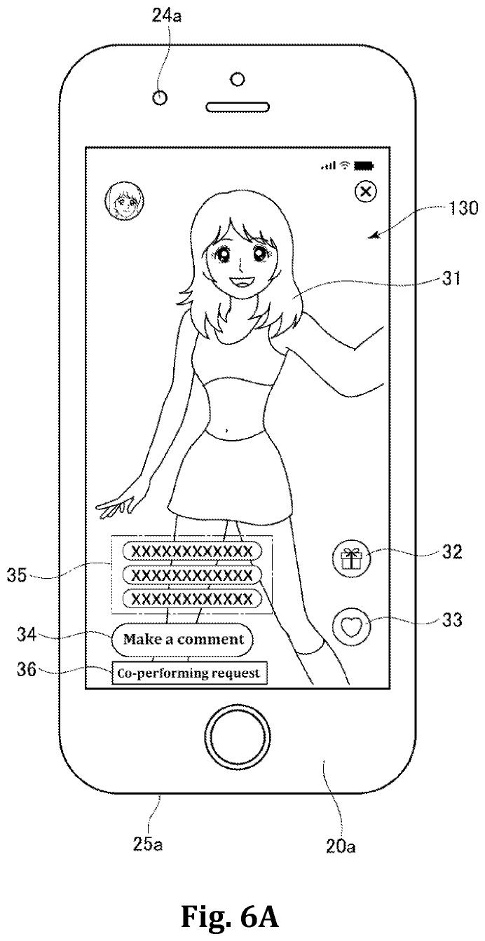

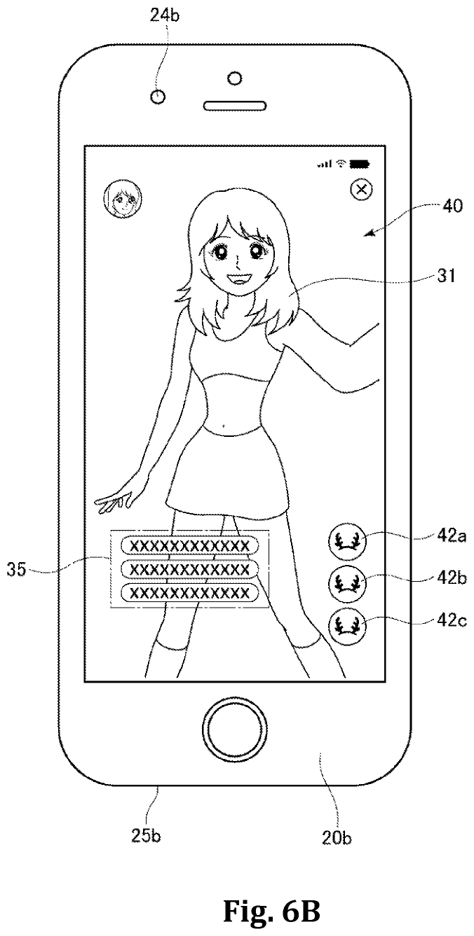

Examples of a view of a video distributed by the video distribution unit 61c are shown in FIGS. 5 and 6A to 6B. In these illustrated examples, it is assumed that the distributor user Ub distributes a video that includes its own character object by using the distributor user device 20b, and the video is played on the viewer user device 10 and the distributor user devices 20a and 20b. In FIG. 6A, the distributor user Ua does not distribute a video and is viewing the video distributed by the distributor user Ub, which is a different user from the distributor user Ua. Accordingly, in the description of FIGS. 5, and 6A to 6B, the distributor user Ua may also be referred to as a viewer user. FIG. 5 shows an example of a view of a video played on the viewer user device 10, FIG. 6A shows an example of a view of a video played on the distributor user device 20a, and FIG. 6B shows an example of a view of a video played on the distributor user device 20b.

As shown in FIG. 5, a view 30 of a video distributed from the server device 60 is displayed on the display of the viewer user device 10. The view 30 on the screen of the viewer user device 10 includes a character object 31 corresponding to the distributor user Ub generated by the animation generation unit 61a, a gift button 32, an evaluation button 33, a comment button 34, and a comment display area 35.

As shown in FIG. 6A, a view 130 of a video distributed from the server device 60 is displayed on the display of the distributor user device 60. Similarly to the view 30, the view 130 on the screen of the viewer user device 10 includes the character object 31 corresponding to the distributor user Ub, a gift button 32, an evaluation button 33, a comment button 34, and a comment display area 35. In addition, the view 130 includes a co-performing request button 36 for requesting for co-performance with the distributor user Ub in the video being distributed by the distributor user Ub. The distributor user device 20a is able to display the view 130 of the distributed video by executing an application software including the viewing program, for example.

As shown in FIG. 3, in one embodiment, the view 30 on the viewer user device 10 does not include the co-performing request button 36. For example, when an application software including the distribution program is not downloaded or installed in the viewer user device 10, or when the application software including the distribution program is not activated in the viewer user device 10, the view 30 on the screen of the viewer user device 10 is generated such that the co-performing request button 36 is not included in the view. In other embodiment, the co-performing request button 36 may also be displayed in the view 30 on the screen of the viewer user device 10. For example, when the application software including the distribution program is downloaded or installed in the viewer user device 10, or when the application software including the distribution program has been activated in the viewer user device 10, the view 30 on the screen of the viewer user device 10 is generated such that the co-performing request button 36 is included in the view.

Since the character object 31 is generated by applying the face motion data of the distributor user Ub to the model data included in the model data 63a as described above, the character object 31 changes its facial expression in synchronization with the change in the facial expression of the distributor user Ub. When the body motion data is provided from the distributor user device 20, the character object 31 may be controlled such that its body parts other than the face also move in synchronization with the body movement of the distributor user Ub.

The gift button 32 is displayed on the view 30 such that it is selectable by an operation on the viewer user device 10. The gift button 32 may be selected, for example, by tapping a region of a touch-screen panel of the viewer user device 10 where the gift button 32 is displayed. In one embodiment, when the gift button 32 is selected, a window for gifting appears in the view 30 and the viewer user is able to select a gift to be gifted to the distributor user of the video which the viewer user is watching. The viewer user is able to purchase a gift to be gifted to the distributor user from among the gifts displayed in the window. In another embodiment, in response to selection of the gift button 32, the view 30 displays a window including a list of purchased gifts. In this case, the viewer user is able to select a gift to be gifted to the distributor user from among the listed gifts displayed in the window. When the gift button 32 is selected on the viewer user device 10, gifting information may be sent to the server device 60. The gifting information may include gift identification information (gift ID) that identifies a gift to be given. In this way, by selecting the gift button 32, the viewer user who is viewing the video is able to provide a desired gift (gifting) to the distributor user who is distributing the video.

The evaluation button 33 is displayed on the view 30 such that it is selectable by a viewer user using the viewer user device 10. The evaluation button 33 may be selected, for example, by tapping a region of the touch-screen panel of the viewer user device 10 where the evaluation button 33 is displayed. When the evaluation button 33 is selected by the viewer user who is viewing a video, evaluation update information indicating that a positive evaluation of the distributor user (in the illustrated example, the distributor user Ub) who is distributing the video or of the video being distributed has been made may be sent to the server device 60. The server device 60 may update the co-performing requester information based on the evaluation update information from the viewer user. For example, at least one of the user evaluation information and the video evaluation information included in the co-performing information may be updated based on the evaluation update information from the viewer user. For example, when the evaluation button 33 included in the view 30 shown in FIG. 5 is selected by the viewer user, at least one of the user evaluation information and the video evaluation information of the distributor user Ub who is delivering the video displayed on the viewer user device 10 may be updated. Once the evaluation button 33 is selected, evaluation information indicating that a positive evaluation has been made on the video may be transmitted to the server device 60. Evaluation information indicating that a positive evaluation has been made on a video may be referred to as positive evaluation information, and evaluation information indicating that a negative evaluation has been made on the video may be referred to as negative evaluation information. When the server device 60 receives the positive evaluation information, it may increase the user evaluation information or the video evaluation information or both. Alternatively when the server device 60 receives the positive evaluation information, it may decrease the user evaluation information or the video evaluation information or both.

The comment button 34 is displayed in the view 30 such that it is selectable by a user. When the comment button 34 is selected by, for example, tapping, a comment input window for writing a comment is displayed on the view 30. The viewer user is able to write a comment via an input mechanism of the viewer user device 10 or the distributor user device 20a. The inputted comment is transmitted to the server device 60 from the viewer user device 10 and the distributor user device 20a. The server device 60 receives comments from the viewer user device 10, the distributor user device 20a, and any other user devices, and displays the comments in the comment display area 35 in the view 30. In the comment display area 35, comments posted from users are displayed, for example, in a timeline manner. The comment display area 35 occupies a part of the view 30. The number of comments that can be displayed in the comment display area 35 is limited. In the illustrated example, up to three comments can be displayed in the comment display area 35. When the number of comments exceeding the upper limit are posted in the comment display area 35, comments are deleted from the comment display area 35 in order from the oldest one. Therefore, the higher the frequency of comments received is, the shorter the display time of each comment in the comment display area 35 becomes.

As shown in FIG. 6B, a view 40 of the video distributed from the server device 60 is displayed on the display of the distributor user device 20b. The view 40 on the screen of the distributor user device 20b includes the character object 31 corresponding to the distributor user Ub, display instruction buttons 42a to 42c for displaying gifts received from viewer users, and the comment display area 35. The view 40 on the screen of the distributor user device 20b includes the same background image, character object image, and comment(s) as the view 30 and the view 130. The view 40 is different from the views 30 and 130 in that the view 40 does not include the gift button 32, the evaluation button 33, the comment button 36, and the co-performing request button but includes the display instruction buttons 42a to 42c.

The co-performing request determination unit 61d determines whether to approve a co-performing request from a user when the co-performing request is received from the user. The co-performing request is transmitted to the server device 60, for example, in response to selection of the co-performing request button 36 during the user is viewing the delivered video, and the transmitted co-performing request is received by the server device 60. The user who makes the co-performing request may be herein referred to as a co-performing requester user, and the user who receives the co-performing request may be referred to as an original user. For example, when the user B makes the co-performing request to the user A who is distributing a video, the user A is the original user and the user B is the co-performing requester user. In the following description, it is assumed that the distributor user Ua who is viewing the video including the character object 31 of the distributor user Ub makes the co-performing request to the distributor user Ub. The distributor user Ua is able transmit the co-performing request for co-performing with the distributor user Ub from the distributor user device 20a to the server device 60 by selecting the co-performing request button 36 on the distributor user device 20a. In this example, the distributor user Ua is the co-performing requester user. In response to the selection of the co-performing request button 36, the application software including the distribution program may be activated in the distributor user device 20a. The server device may receive not only the co-performing request from the distributor user Ua but also the co-performing requests from various other distributor users.

In one embodiment, when a co-performing request for performing with the distributor user Ub is received from the distributor user Ua, the co-performing request determination unit 61d determines whether to permit co-performance between the distributor user Ua and the distributor user Ub based at least in part on the co-performing requester information of the distributor user Ua who is the co-performing requester user. In one embodiment, the co-performing request determination unit 61d determines whether to permit the co-performing of the distributor user Ua based on the user evaluation information in the co-performing requester information of the distributor user Ua who is the co-performing requester user. In the case where the user evaluation information is the user evaluation points, the co-performing of the distributor user Ua with the distributor user Ub is permitted when the user evaluation points are greater than a predetermined threshold, and the co-performing of the distributor user Ua with the distributor user Ub is rejected when the user evaluation points are less than the predetermined threshold. As mentioned above, the user evaluation points may be updated by a feedback from other user. The user evaluation information may be other than the user evaluation points. For example, the user evaluation information of a user may be the quantity of gifts received by the user. Since the gift is given from the viewer user to the distributor user, the quantity of the gift given to a user is considered to represent the evaluation of the user. The user evaluation information applicable to the invention is not limited to those expressly described herein. By determining whether to approve the co-performing with the distributor user Ua based on the user evaluation information of the distributor user Ua, it is possible to permit only users who are highly evaluated by other users to co-perform.

In one embodiment, the co-performing request determination unit 61d determines whether to permit the co-performing of the distributor user Ua based on the video evaluation information in the co-performing requester information of the distributor user Ua who is the co-performing requester user. In the case where the video evaluation information is the video evaluation points, the co-performing of the distributor user Ua with the distributor user Ub is permitted when the video evaluation points are greater than a predetermined threshold, and the co-performing of the distributor user Ua with the distributor user Ub is rejected when the video evaluation points are less than the predetermined threshold. The video evaluation information applicable to the invention is not limited to those expressly described herein. By determining whether to approve the co-performing with the distributor user Ua based on the video evaluation information indicating the evaluation of the videos that the distributor user Ua has distributed, it is possible to permit only users who distributed videos that were highly evaluated by other users to co-perform.

In one embodiment, the co-performing request determination unit 61d determines whether to permit the co-performing of the distributor user Ua based on one or both of the distribution time and the number of distributions in the co-performing requester information of the distributor user Ua who is the co-performing requester user. The co-performing request determination unit 61d may permit the co-performing of the distributor user Ua with the distributor user Ub when at least one of the distribution time and the number of distributions is larger than a respective threshold value. Alternatively the co-performing request determination unit 61d may permit the co-performing of the distributor user Ua with the distributor user Ub when both of the distribution time and the number of distributions are larger than respective threshold values. By determining whether to permit the distributor user Ua to co-perform based on the distribution time and/or the number of distributions of the videos distributed by the distributor user Ua, it is possible to permit only users who actively distribute videos to co-perform.

In one embodiment, the co-performing request determination unit 61d determines whether to permit the co-performing of the distributor user Ua based on the co-performing ban information in the co-performing requester information of the distributor user Ua who is the co-performing requester user. For example, the co-performing request determination unit 61d rejects the distributor user Ua's co-performing with the distributor user Ub when the user ID of the distributor user Ub is included in the co-performing ban information, and the co-performing request determination unit 61d permits the distributor user Ua's co-performing with the distributor user Ub when the user ID of the distributor user Ub is not included in the co-performing ban information. By referring to the co-performing ban information, it is possible to avoid co-performing with a user who is banned from co-performing.

In one embodiment, when a co-performing request for performing with the distributor user Ub is received from the distributor user Ua, the co-performing request determination unit 61d determines whether to permit co-performing between the distributor user Ua and the distributor user Ub based on at least some of the co-performing requester information of the distributor user Ub, which is the original user. For example, the co-performing request determination unit 61d rejects the distributor user Ua's co-performing with the distributor user Ub when the user ID of the distributor user Ua is included in the co-performing ban information of the distributor user Ub, and the co-performing request determination unit 61d permits the distributor user Ua's co-performing with the distributor user Ub when the user ID of the distributor user Ua is not included in the co-performing ban information. By referring to the co-performing ban information included in the co-performing requester information of the original user, it is possible to avoid co-performing with a user who is banned from co-performing. In one embodiment, the co-performing request determination unit 61d may determine whether to permit co-performing between the co-performing requester user and the original user by referring to the co-performing ban information included in the co-performing requester information of other user than the original user, instead of or in addition to the co-performing requester information of the original user. For example, when the distributor user Ua made the co-performing request for co-performing with the distributor user Ub, the co-performing request determination unit 61d may reject the distributor user Ua's co-performing with the distributor user Ub when the user ID of the distributor user Ua is included in the co-performing ban information in the co-performing requester information of a distributor user Uc, which is different from either the distributor user Ua or distributor user Ub. The co-performing request determination unit 61d may reject co-performing between the co-performing requester user and the original user when the user ID of the co-performing requester user is included in the co-performing ban information in the co-performing requester information of multiple users other than the co-performing requester user and the original user.

The co-performing request determination unit 61d may determine whether to permit the co-performing by combining the above-described determination conditions. For example, by combining the condition related to the user evaluation information and the condition related to distribution time, it is possible to permit only users who are highly evaluated by other users and actively distribute videos to co-perform. As the popularity of a distributor user increases, there is a possibility that there will be a flood of co-performing requests to the popular distributor user from other users. In such a case, it is possible to screen a large number of co-performing requester users and select a desirable co-performer(s) by tightening the conditions for permitting the co-performing used by the co-performing request determination unit 61d. The permission condition used in the co-performing request determination unit 61d may be changed depending on the popularity of the user who has received the co-performing request (in the above example, the distributor user Ub). For example, a threshold value set for the user evaluation points, the video evaluation points, the distribution time, the number of distributions, and any other co-performing requester information may be increased depending on the popularity of the user who has received the co-performing request. The popularity of the user who has received the co-performing request may be determined, for example, based on the number of the viewer users who viewed the video distributed by the user.

In one embodiment, the co-performing request processing unit 61e generates a co-performing video in which the distributor user Ua and the distributor user Ub appear together based on the co-performing request when the co-performing request is approved in the co-performing request determination unit 61d. In order to generate the co-performing video, the co-performing request processing unit 61e obtains the face motion data and the voice data of the distributor user Ua from the distributor user Ua. The face motion data of the distributor user Ua may be transmitted from the distributor user device 20a to the server device 60 together with the co-performing request, or it may be transmitted to the server device 60 from the distributor user device 20a in response to a request from the server device 60 after the co-performing request is approved. When body movements of the distributor user Ua are also expressed as an animation, the body motion data of the distributor user Ua may be provided to the server device 60 together with the face motion data. When the face motion data cannot be obtained from the distributor user Ua, the co-performing request processing unit 61e may obtain only the voice data from the distributor user Ua. For example, when the distributor user device 20a used by the distributor user Ua does not have the function of the face motion data generation unit 211a or other functions for video distribution or when the functions are disabled or in any other cases where the face motion data cannot be obtained, the co-performing request processing unit 61e may obtain the voice data without obtaining the face motion data (and the body motion data) from the distributor user Ua. The co-performing request processing unit 61e may also perform processing to make the co-performing request button 36 undisplayed (disable the co-performing request button 36) in the view on the screen of the distributor user device of each distributor user when the co-performing request has been permitted in the co-performing request determination unit 61d. This prevents extra co-performing requests from being made once the co-performing is permitted.

In one embodiment, the co-performing request processing unit 61e adds an animation of the character object of the distributor user Ua to the video being distributed that includes the character object 31 of the distributor user Ub based on the face motion data of the distributor user Ua to generate the co-performing video. The animation of the character object of the distributor user Ua may be generated in the animation generation unit 61a based on the face motion data of the distributor user Ua. The animation of the character object of the distributor user Ua may be generated by applying the face motion data of the distributor user Ua to a model data for the distributor user Ua included in the model data 63a. For example, the co-performing request processing unit 61e generates a layer including the animation of the character object of the distributor user Ua, and superimposes this layer on the video that includes the character object 31 of the distributor user Ub to generate a co-performing video that includes the character object of the distributor user Ua and the character object 31 of the distributor user Ub. By generating the co-performing video that includes the character object of the distributor user Ua and the character object 31 of the distributor user Ub, it is possible to virtually co-perform in the co-performing video even when the distributor user Ua and the distributor user Ub use the video distribution system 1 from locations apart from each other. When the co-performing request processing unit 61e obtains the voice data without obtaining the face motion data (and body motion data) from the distributor user Ua, it is possible to generate a co-performing video that includes the character object 31 of the distributor user Ub and the voice of the distributor user Ua by superimposing a voice generated based on the voice data obtained from the distributor user Ua on the video that includes the the character object 31 of the distributor user Ub. When a model data for the distributor user Ua is not included in the model data 63a, it is also possible for the co-performing request processing unit 61e to generate the co-performing video that includes the character object 31 of the distributor user Ub and the voice of the distributor user Ua by superimposing the voice generated based on the voice data obtained from the distributor user Ua on the video that includes the the character object 31 of the distributor user Ub. As described above, the distributor user Ua is able to co-perform with the distributor user Ub by his/her own voice.

When the co-performing request processing unit 61e is unable to obtain the face motion data from the distributor user Ua, the co-performing request processing unit 61e may first distribute the co-performing video including the voice of the distributor user Ua and the character object 31 of the distributor user Ub. The co-performing request processing unit 61e may thereafter generate a character object of the distributor user Ua based on face motion data of the distributor user Ua when it obtained the face motion data from the distributor user Ua and generate a co-performing video that includes the character object of the distributor user Ua and the character object 31 of the distributor user Ub. In this way, the co-performing request processing unit 61e may switch the co-performing video that includes the voice of the distributor user Ua and the character object 31 of the distributor user Ub to the co-performing video that includes the character object of the distributor user Ua and the character object 31 of the distributor user Ub. On the contrary, the co-performing request processing unit 61e may switch the co-performing video that includes the character object of the distributor user Ua and the character object 31 of the distributor user Ub to the co-performing video that includes the voice of the distributor user Ua and the character object 31 of the distributor user Ub. As described above, the co-performing video using voice to co-perform (may be referred to as a “voice co-performing video”) and the co-performing video in which character objects are appear together (may be referred to as a “character co-performing video”) may be switchable alternately.

The generated co-performing video is distributed by the video distribution unit 61c. The co-performing video may be created by the distributor user device 20a. When the co-performing video is generated by the distributor user device 20a, the co-performing video is transmitted from the distributor user device 20a to the server device 60 and distributed by the video distribution unit 61c of the server device 60.

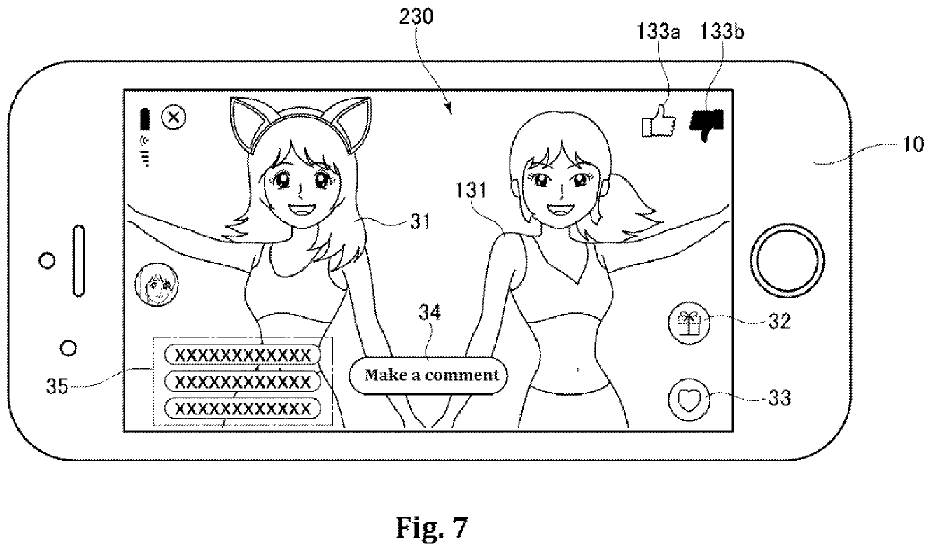

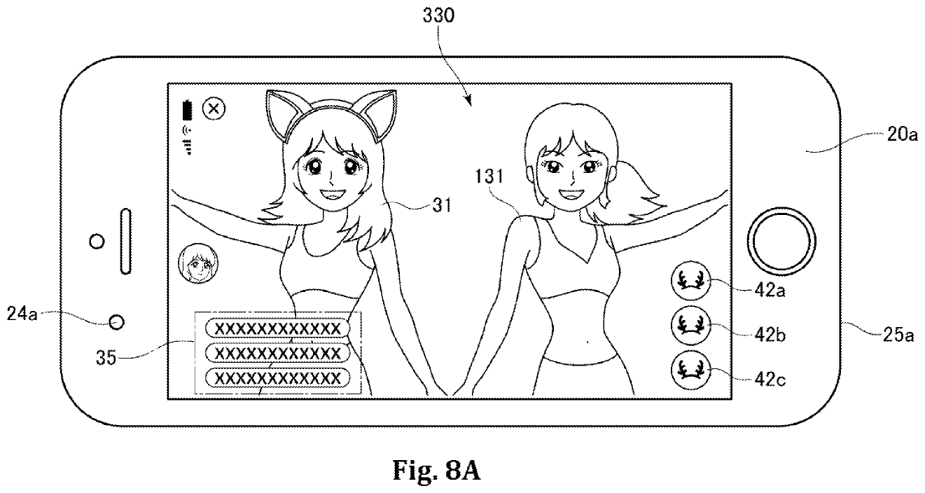

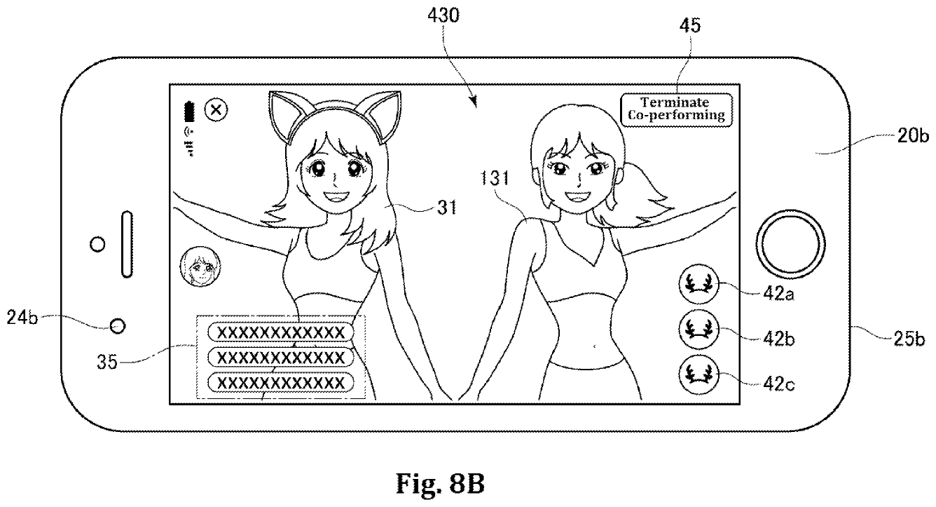

Examples of a view of the co-performing video distributed by the video distribution unit 61c are shown in FIGS. 7 and 8A to 8B. In these figures, it is assumed that the co-performing request from the distributor user Ua to the distributor user Ub is permitted and the co-performing video that includes the character object 131 of the distributor user Ua and the character object 31 of the distributor user Ub is distributed.

As shown in FIG. 7, a view 230 of the video distributed from the server device 60 is displayed on the display of the viewer user device 10. The display image 230 of the co-performing video displayed on the viewer user device 10 includes a character object 131 of the distributor user Ua in addition to the character object 31 of the distributor user Ub. The character object 131 of the distributor user Ua is generated by the animation generation unit 61a or the co-performing request processing unit 61e as described above. The view 230 of the co-performing video includes the gift button 32, the evaluation button 33, the comment button 34, and the comment display area 35, similar to the original distribution image shown in FIG. 5. In addition to these, the view 230 of the co-performing video includes guest evaluation buttons 133a and 133b. The guest evaluation button 133a is a button for transmitting positive evaluation information indicating a positive evaluation of the guest user (in the illustrated example, the distributor user Ua is the guest user) to the server device 60, and the guest evaluation button 133b is a button for transmitting negative evaluation information indicating a negative evaluation of the guest user to the server device 60.

As shown, a distribution image 230 of the co-performing video is horizontally long. When the co-performing request processing unit 61e or the video distribution unit 61c distributes the co-performing video, it distributes the video such that it has a horizontally long view. Thus, the distribution image 230 of the co-performing video is displayed as a horizontally long image on the viewer user device 10. In one embodiment, even if the original video (image) is vertically long as shown in FIG. 4, the co-performing image is converted to the horizontally long image and distributed. The co-performing video includes the character objects of the two distributor users, therefore it would be easier to display the character objects of the two people without overlapping from each other by making the image horizontally long. For example, in the co-performing video, the left half of the image from the viewpoint of the viewer user may be an area allocated to the character object of the original distributor user and the right half may be an area allocated to the character object of the distributor user who made the co-performing request. An area of the image may be adequately allocated to each distributor user such that their character objects do not overlap with each other.

As shown in FIG. 8A, a view 330 of a co-performing video distributed from the server device 60 is displayed on the display of the distributor user device 20a used by the distributor user Ua. The view 330 includes the same background image, character object image, and comment(s) as the view 230. The view 330 is different from the view 230 in that the view 40 does not include the gift button 32, the evaluation button 33, the comment button 36, and the co-performing request button but includes the display instruction buttons 42a to 42c.

As shown in FIG. 8B, a view 430 of the co-performing video distributed from the server device 60 is displayed on the display of the distributor user device 20b. The display image 430 includes the same background image as the image 330 displayed on the distributor user device 20a of the distributor user Ua who is the co-performer, the character objects 31, 131, the comment display area 35, and the display instruction buttons 42a to 42c. Whereas the view 430 includes a co-performing termination button 45 for ending the co-performing. The co-performing termination button 45 is displayed in the view 430 on the screen of the distributor user Ub who has received the co-performing request, but is not displayed in the view on the screen of the distributor user Ua who has made the co-performing request. When the co-performing termination button 45 is selected on the distributor user device 20b of the distributor user Ub (host user), a process for terminating the co-performing with the distributor user Ua is performed in the co-performing video. For example, in response to the selection of the co-performing termination button 45, a co-performing termination instruction is transmitted from the distributor user device 20b to the server device 60. The distributor user Ub may set the distributor user Ua, who is the co-performer, as a co-performing banned user while playing the co-performing video. For example, when the distributor user Ua behaves or speaks inappropriately in the co-performing video, the distributor user Ua can be set as the co-performing banned user. For example, by registering the user ID of the distributor user Ub in the co-performing ban information of the co-performing requester information of the distributor user Ua. For example, when the server device 60 received the co-performing termination instruction from the distributor user device 20b, the server device 60 may automatically register the distributor user Ua as the co-performing banned user in the co-performing requester information of the distributor user Ub. The distributor user Ub may set the distributor user Ua as the co-performing banned user any time other than when playing the co-performing video. For example, the distributor user Ua may be set as the co-performing banned user in response to acknowledgment of an inappropriate message posted by the distributor user Ua through a messaging service provided by the video distribution system 1.

A warning button (not shown) for giving a warning to the guest user may be displayed in the view 430 on the screen of the distributor user Ub, which is the host user. This warning button is displayed in the view 430 of the host user, but is not displayed in the view of the guest user. Unlike the co-performing termination button 45, the warning button does not end the co-performing immediately, but it is assumed that the warning button is selected by the host user when the guest user behaves undesirably for the host user. When the warning button is selected in the distributor user device of the host user (for example, the distributor user device 20b of the distributor user Ub), the distributor user device 20b transmits a warning instruction to the server device 60. Once the warning button is selected in the distributor user device of the host user, warning information indicating that a warning has been given by the host user may be displayed in the view 330 of the co-performing video displayed on the distributor user device of the guest user (for example, the distributor user device 20a of the distributor user Ua). By displaying the warning information in the view 330 of the viewer user, it is possible to inform the viewer user that the host user is addressing to the undesired behavior of the guest user. The warning information may be displayed in the view 230 of the viewer user device 10 in place of the view 330 or in addition to the view 330. The co-performing video including the warning information may be generated in the server device 60. The server device 60 may counts the number of times the warning instruction is given from a host user to a guest user, and when the number of the warning instructions reaches a predetermined number of times (for example, three times), a process for ending the co-performing between the host user and the guest user may be performed. The process for ending the co-performing based on the warning instructions more than the predetermined number of times may be the same process as the above-described process for ending the co-performing based on the co-performing termination instruction.

The co-performing request processing unit 61e may issue a video ID that identifies a crated co-performing video. The co-performing video information related to the co-performing video may be stored in the storage 63 in association with the video ID. As described above, in association with the video ID of the co-performing video being distributed, the co-performing time information of the co-performing video may be updated. The distribution time of the co-performing video may be monitored in the video distribution unit 61c and the co-performing time information may be updated based on the monitoring result.

Of the co-performing video information, the co-performing user evaluation information may be updated based on positive evaluation information indicating a positive evaluation of the distributor user Ua who is the guest user from the viewer user device 10 and negative evaluation information indicating a negative evaluation of the distributor user Ua. For example, when the server device 60 receives the positive evaluation information indicating a positive evaluation of the distributor user Ua from the viewer user device 10, the co-performing user evaluation points may be increased. Whereas when the server device 60 receives the negative evaluation information indicating a negative evaluation of the distributor user Ua from the viewer user device 10, the co-performing user evaluation points may be decreased. If the viewer user stops viewing the co-performing video halfway, it may be considered that the viewer user is not satisfied with the co-performing video. Therefore, when the viewer user drops out of viewing the co-performing video, it may be considered as a negative evaluation of the guest user and the co-performing user evaluation points of the guest user may be decreased. At least one of the positive evaluation information and the negative evaluation information may be updated such that it decreases as time advances. For example, when the distributor user Ua has 100 points of positive evaluation information at a certain time, the positive evaluation information may be updated such that it approaches zero with the passage of time. When the negative evaluation information for one user exceeds a predetermined value, his/her co-performing with another user may be banned. For example, in a view displayed on the distributor user device of the user whose negative evaluation information exceeds a predetermined value, a process for undisplaying the co-performing request button may be performed.

The co-performing termination processing unit 61f performs the process for terminating the co-performing between the distributor user Ua, which is the the guest user, and the distributor user Ub, which is the host user, when the co-performing termination condition for terminating the co-performing between the guest user distributor user Ua and the host user distributor user Ub. In one embodiment, when the co-performing termination processing unit 61f receives the co-performing termination instruction from the distributor user device 20b of the distributor user Ub who is the host user, it determines that the co-performing termination condition is satisfied and performs the process for terminating the distribution of the co-performing video. For example, when the co-performing termination processing unit 61f receives the co-performing termination instruction, generation of the animation of the character object 131 of the distributor user Ua is stopped, and a video that does not include the character object 131 of the distributor user Ua but includes the character object 31 of the distributor user Ub is generated. In other words, the character object 131 of the distributor user Ua, which is the guest user, is excluded from the video to be distributed. By eliminating the character object 131 of the distributor user Ua, which is the guest user, from the video, the co-performing between the distributor user Ua and the distributor user Ub ends. After the co-performing is terminated, the distribution of the video that includes the character object 31 but does not include the character object 131 may be continued. The video distributed after the termination of the co-performing may be generated as a vertically long video as shown in FIG. 4. That is, the orientation of the video may be changed in response to the termination of the co-performing. In one embodiment, the orientation of the video may be changed from the horizontally long to the vertically long in response to the termination of the co-performing. In another embodiment, the distribution of the video by the distributor user Ub, which is the host user, may be terminated in response to the termination of the co-performing. In one embodiment, if a co-performing request from another user has already been received at the time when the co-performing with the distributor user Ub is terminated, the co-performing request determination unit 61d may determine whether to permit the other user's co-performing based on the co-performing request. In another embodiment, the co-performing termination processing unit 61f may resume accepting a co-performing request from other users in response to the termination of the co-performing with the distributor user Ub. For example, a process for displaying the co-performing request button 36 again (releasing the disabled state of the co-performing request button 36) may be performed in the view on the distributor user device of each distributor user.

In one embodiment, the co-performing termination processing unit 61f determines whether the character object 131 of the distributor user Ua, which is the guest user, is in an inactive state. When it is determined that the character object 131 is in the inactive state, the co-performing termination processing unit 61f determines that the co-performing termination condition is satisfied. In one embodiment, whether the character object 131 of the distributor user Ua is in the inactive state is determined based on at least one selected from the group consisting of the face motion data, the body motion data, and the voice data received from the distributor user device 20a of the distributor user Ua. Since the face motion data, the body motion data, and the voice data are all data indicating motion of the distributor user, they may be herein collectively referred to as “motion data”. Whether the character object 131 of the distributor user Ua is in the inactive state is determined based on the motion data, that is, based on at least one selected from the group consisting of the face motion data, the body motion data, and the voice data. For example, when there is no face motion data input from the distributor user device 20a of the distributor user Ua for a certain period of time, the facial expression of the character object 131 of the distributor user Ua does not change for the certain period of time in the co-performing video. Thus it may be determined that the character object 131 is in the inactive state. When there is no body motion data input from the distributor user device 20a of the distributor user Ua for a certain period of time, the body of the character object 131 of the distributor user Ua does not move for the certain period of time in the co-performing video. Thus it may be determined that the character object 131 is in the inactive state. When there is no voice data input from the distributor user device 20a of the distributor user Ua for a certain period of time, the character object 131 of the distributor user Ua does not speak for the certain period of time in the co-performing video. Thus it may be determined that the character object 131 is in the inactive state.

In one embodiment, the co-performing termination processing unit 61f terminates the co-performing by excluding the character object 131 of the distributor user Ua, which is the guest user, from the video depending on the co-performing video information of the co-performing video being distributed. For example, when the co-performing user evaluation information is the co-performing user evaluation points, the co-performing termination processing unit 61f excludes the character object 131 of the distributor user Ua from the video when the co-performing user evaluation points becomes smaller than a predetermined threshold value. The co-performing user evaluation points becomes smaller as the distributor user Ua, which is the guest user, receives more negative evaluation information from viewer users. Therefore, by determining whether to terminate the co-performing with the distributor user Ua based on the co-performing user evaluation points, it is possible to avoid co-performing for a long period of time with a user who has a low evaluation from the viewer users.

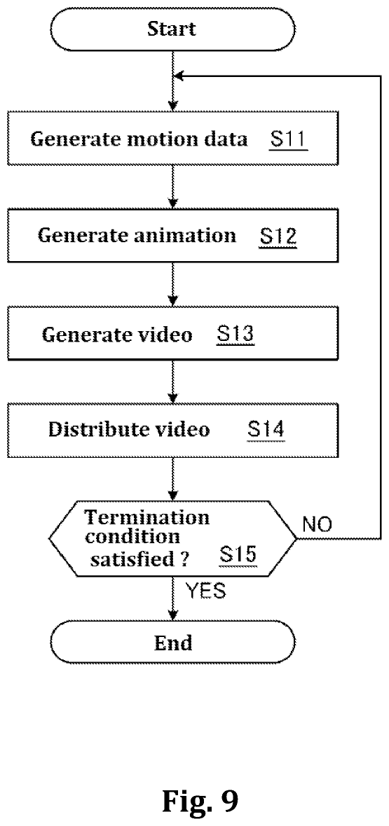

Next, with reference to FIG. 9, a video distribution process in one embodiment will be described. FIG. 9 is a flow chart showing the flow of the video distribution process in one embodiment. In the video distribution process described with reference to FIG. 9, it is assumed that distributed is a video generated based on the face motion data obtained using the distributor user device 20b by the distributor user U1.

In step S11, the face motion data, which is a digital representation of the movement (expression) of the face of the distributor user Ub, is generated. The generation of the face motion data is performed, for example, by the face motion data generation unit 121b in the distributor user device 20b. In the distributor user device 20b, the voice data may be generated based on voice inputs by the distributor users Ua and Ub. The generated face motion data and voice data are transmitted to the server device 60.

In step S12, the face motion data from the distributor user device 20 is applied to model data for the distributor user Ub to generate animation of the character object that moves in synchronization with the facial motion (expression) of the distributor users Ub. The generation of the animation is performed, for example, by the above-described animation generation unit 61a.

In step S13, a video including the animation of the character object 31 corresponding to the distributor user Ub is generated. The voice of the distributor user Ub may be included in the video. The animation of the character object 31 is displayed superimposed on the background image. Generation of the video is performed, for example, by the above-described video generation unit 61b.

Next, the process proceeds to step S14 where the video generated in step S13 is distributed. The video is distributed to the viewer user device 10 and other viewer user devices and the distributor user device over the network 50. When the distributed video is played on the viewer user device 10, for example, the view as shown in FIG. 4 is displayed on the screen of the viewer user device 10. The video is distributed continuously over a predetermined distribution period. The distribution period of the video may be set to, for example, 30 seconds, 1 minute, 5 minutes, 10 minutes, 30 minutes, 60 minutes, 120 minutes, and any other length of time. Distribution of the video is performed, for example, by the above-described video distribution unit 61c.

Subsequently in step S15, it is determined whether a termination condition for ending the distribution of the video is satisfied. The termination condition is, for example, that the distribution ending time has come, that the distributor user Ub performed a distribution ending operation on the distributor user device 20 to end the distribution, or any other conditions. If the termination condition is not satisfied, the steps S11 to S14 of the process are repeatedly executed, accordingly distribution of the video that includes the animation synchronized with the motion of the distributor user U1 is continued or distribution of the co-performing video is continued when the co-performance is on-going. When it is determined that the termination condition is satisfied for the video, the distribution process of the video is ended.

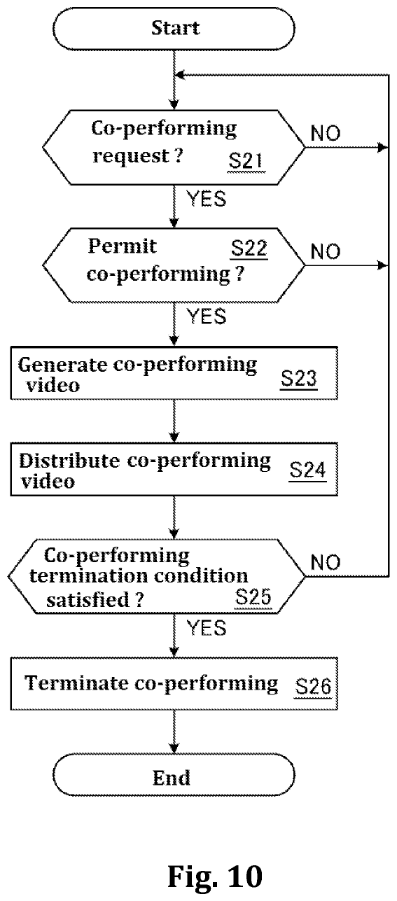

A distribution process of a co-performing video in one embodiment will be now described with reference to FIG. 10. FIG. 10 is a flow chart showing flow of a process of distributing the co-performing video in one embodiment. In the distribution process of the co-performing video described with reference to FIG. 10, it is assumed that the distributor user Ua who is viewing a video containing the character object of the distributor user Ub makes the co-performing request to the distributor user Ub. The co-performing video distribution process is performed in parallel with the video distribution process illustrated in FIG. 9.

First, it is determined in step S21 whether the co-performing request has been made by a user other than the distributor user Ub during distribution of the video that includes the character object of the distributor user Ub. The co-performing request is made, for example, by the distributor user Ua. When the co-performing request has been made by the distributor user Ua, proceeds to step S22.

In step S22, it is determined whether to permit the co-performing request from the distributor user Ua who applied for co-performing. Whether to permit the co-performing request is determined based on at least some of the co-performing applicant information of the distributor user Ua. For example, when the user evaluation points in the co-performing requester information of the distributor user Ua is larger than a predetermined threshold value, the distributor user Ua's co-performing with the distributor user Ub is permitted. Whereas when the user evaluation points are less than the threshold value, the distributor user Ua's co-performing request is rejected. For example, the determination whether to permit the co-performing request is performed by the co-performing request determination unit 61d.

When it is determined in step S22 that the the co-performing request is permitted, proceed to step S23. In step S23, an animation of the character object 131 of the distributor user Ua is generated based on the face motion data of the distributor user Ua. Then, a co-performing video is generated by adding the animation of the character object 131 of the distributor user Ua to the video being distributed (the video including the character object 31 of the distributor user Ub). The process of step S16 is performed, for example, by the co-performing request processing unit 61e described above.

The process proceeds to step S24. In step S24, the co-performing video generated in step S23 is distributed. The co-performing video is distributed to the viewer user device 10 and other viewer user devices and the distributor user device over the network 50. The co-performing video includes, for example, the animation of the character object 131 of the distributor user Ua and the animation of the character object 31 of the distributor user Ub, as shown in FIGS. 7, 8A and 8B.

The process proceeds to step S25. In step S25, it is determined whether the co-performing termination condition is satisfied. For example, it is determined that the co-performing termination condition is satisfied when any of the following conditions is satisfied: the character object 131 of the distributor user Ua, which is the guest user, is in the inactive state; the co-performing user evaluation points becomes equal to or less than a predetermined threshold value; the co-performing termination instruction is received from the distributor user Ub, which is the host user; or a predetermined time or more has elapsed from the start of distribution of the co-performing video. When the co-performing termination condition is satisfied, the process proceeds to step S26.

In step S26, the process for terminating the distribution of the co-performing video is performed. For example, the character object 131 of the distributor user Ua, which is the guest user, is excluded from the co-performing video to terminate the distributor user Ua's the co-performing with the distributor user Ub. Even if the co-performing is over, the video may continue to be distributed. The video distributed after the co-performing is terminated does not include the character object 131 of the distributor user Ua. The determination of the co-performing termination condition and the co-performing termination process are performed by, for example, the co-performing termination processing unit 61f.

According to the above embodiment, in response to the reception of the co-performing request for co-performing with the distributor user Ub from the distributor user Ua, whether to permit the distributor user Ua's co-performing with the distributor user Ub is determined based on the co-performing requester information related to the distributor user Ub. When it is determined to permit the co-performing, a co-performing video is generated and distributed. In this way, it is possible to select a co-performer based on the co-performing requester information.

In one embodiment described above, the co-performing requester information includes the user evaluation information indicating an evaluation of the distributor user Ua who has made the co-performing request. Therefore, it is possible to screen co-performers based on the evaluation of the users who have made the co-performing request. It is further possible to permit co-performing only when the distributor user Ua is highly evaluated by other users.

In one of the above embodiments, the co-performing requester information includes the video evaluation information for the video distributed by the distributor user Ua. Thus, the co-performer can be selected based on the evaluation of the videos distributed by the user who has made the co-performing request. Therefore it is possible to permit co-performing only when the videos distributed by the distributor user Ua are highly evaluated by other users.

In the above embodiment, the co-performing requester information includes the video distribution time or the number of video distributions of the distributor user Ua. Thus, the co-performer can be selected based on the video distribution time or the number of video distributions performed by the user who has made the co-performing request. Therefore, it is possible to permit the co-performing only when the distributor user Ua is a kind of user who actively distributes videos.

In one of the above embodiments, the co-performing requester information includes the co-performing ban information that identifies a user that the distributor user Ua is banned from co-performing with. Therefore, when the distributor user Ua is registered as the co-performing banned user, the co-performing with the distributor user Ua is prevented.

In one of the above embodiments, when it is determined that the character object 131 of the distributor user Ua is in the inactive state based on the motion data indicating motion of the distributor user Ua, the character object 131 may be excluded from the co-performing video. In this way, it is possible to exclude the co-performer who does not contribute to the enhancement of the entertainment aspect of the video from the video of the distributor user Ub which is the host user.

In one of the above embodiments, the character object 131 of the distributor user Ua is excluded from the co-performing video based on co-performer evaluation information indicating the evaluation of the distributor user Ua from viewer users. In this way, it is possible to exclude the co-performer who is poorly evaluated by viewers from the video of the host distributor user Ub.

In the above embodiment, the character object 131 of the distributor user Ua may be excluded from the video of the distributor user Ub based on the request from the host distributor user Ub. In this way, it is possible to exclude the co-performer from the video according to the determination of the host distributor user Ub.

In the video distribution system 1 according to the above-described embodiment, the distributor users Ua and Ub are each able to distribute a video including a character object that moves in accordance with his/her facial expression using the distributor user device 20 provided with a camera such as a smartphone. As described above, in the video distribution system 1, the equipment necessary for distributing a video by the distributor users Ua and Ub is simplified, so realized is a platform in which the distributor users Ua and Ub can easily participate.

The procedures described herein, particularly those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions that can be realized by the computer processor 61 may be realized by a computer processor other than the computer processor 61 of the video distribution system 1. At least one of the functions that are realized by the computer processor 21 may be realized by the computer processor 21 in the distributor user device 20 or a computer processor of the viewer user device 10. More specifically, some or all of the functions of the animation generation unit 61a and the video generation unit 61b may be executed by the distributor user device 20. For example, a video generated by the distributor user device 20 may be transmitted to the server device 60 and distributed from the server device 60 to the viewer user device 10.

When the distributor user Ua watching the video that includes the character object 31 of the distributor user Ub makes the co-performing request to the distributor user Ub, the animation of the character object 131 of the distributor user Ua who has made the co-performing request may be generated by any of the server device 60, the distributor user device 20a of the distributor user Ua, the distributor user device 20b of the distributor user Ub, or the viewer user device 10. Further, the generation of the co-performing video that includes the generated character object 131 of the distributor user Ua and the character object 31 of the distributor user Ub may be performed by any of the server device 60, the distributor user device 20a of the distributor user Ua, and the distributor user Ub, the user device 20b or the viewer user device 10. In one example, when the animation of the character object 131 of the distributor user Ua is generated by the distributor user device 20b of the distributor user Ub, the face motion data and the voice data of the distributor user Ua are transmitted from the distributor user device 20a of the distributor user Ua to the distributor user device 20b of the distributor user Ub. In the distributor user device 20b, the animation of the character object 131 is generated by applying the face motion data and the voice data of the distributor user Ua received from the distributor user device 20a to the model data for the distributor user Ua. The model data for the distributor user Ua may be transmitted from the server device 60 to the distributor user device 20a. In another example, when the animation of the character object 131 of the distributor user Ua is generated by the viewer user device 10, the face motion data and the voice data of the distributor user Ua are transmitted from the distributor user device 20a of the distributor user Ua to the viewer user device 10, and the face motion data and the voice data of the distributor user Ub are transmitted from the distributor user device 20b of the distributor user Ub to the viewer user device 10. In the viewer user device 10, the animation of the character object 131 may be generated by applying the face motion data and the voice data of the distributor user Ua received from the distributor user device 20a to the model data for the distributor user Ua, and the animation of the character object 31 may be generated by applying the face motion data and voice data of the distributor user Ub received from the distributor user device 20b to the model data for the distributor user Ub. The model data for the distributor user Ua and the model data for the distributor user Ub may be transmitted from the server device 60 to the distributor user device 10. As described above, the animation of the character object of the distributor user may be generated by any device included in the video distribution system 1. The animation of the character object may be generated by a device not explicitly shown in FIG. 1. The face motion data and voice data of the distributor user Ua are transmitted from the distributor user device 20a of the distributor user Ua to the device that generates the animation of the character object, and the face motion data and voice data of the distributor user Ub is transmitted from the distributor user device 20b of the distributor user Ub to the device that generates the animation of the character object. The body motion data may be transmitted in addition to the face motion data.

The co-performing video may include character objects of three or more distributor users. That is, three or more distributor users may virtually appear in a video using each character object. The number of distributor users who can co-perform may be limited. When the number of distributor users who are co-performing reaches the upper limit, the process for not displaying the co-performing request button 36 on the view (for example, the view 130) of the video viewed by the distributor users, or the process of making the co-performing request button 36 unselectable (disable process) in the view of the video viewed by the distributor users may be performed.

### LIST OF REFERENCE NUMBERS

1 video distribution system

1. A system, comprising:
one or more computer processors,
wherein the one or more computer processors execute computer-readable instructions to:
in response to reception of a co-performing request from a second user for co-performing with a first user, determine whether to permit the second user co-performing with the first user based on co-performing requester information related to the second user; and
distribute data for causing one or more viewer user devices to play a co-performing video in which the first user and the second user co-perform responsive to the second user being permitted to co-perform with the first user.

2. The system of claim 1, wherein the co-performing requester information includes user evaluation information indicating an evaluation of the second user.

3. The system of claim 1, wherein the co-performing requester information includes video evaluation information indicating an evaluation of a video distributed by the second user.

4. The system of claim 1, wherein the co-performing requester information includes a video distribution time or a number of video distributions of the second user.

5. The system of claim 1, wherein the co-performing requester information includes co-performing ban information identifying a user that the second user is banned from co-performing with.

6. A system, comprising:
one or more computer processors,
wherein the one or more computer processors execute computer-readable instructions to:
in response to reception of a co-performing request from a second user for co-performing with a first user, determine whether to permit the second user co-performing with the first user based on co-performing requester information related to the first user; and
distribute data for causing one or more viewer user devices to play a co-performing video in which the first user and the second user co-perform responsive to the second user being permitted to co-perform with the first user.

7. The system of claim 6 wherein the co-performing video is a character co-performing video including a first character object generated based on one or more motions of the first user and a second character object generated based on one or more motions of the second user.

8. The system of claim 6 wherein the co-performing video is a voice co-performing video including a voice of the second user and a first character object generated based on one or more motions of the first user.

9. The system of claim 6 wherein:
the co-performing video comprises:
a character co-performing video including a first character object generated based on one or more motions of the first user and a second character object generated based on one or more motions of the second user, or
a voice co-performing video including a voice of the second user and a first character object generated based on one or more motions of the first user, and
wherein the character co-performing video and the voice co-performing video are alternately switchable.

10. The system of claim 7, wherein when it is determined that the second character object is in an inactive state in the co-performing video based on motion data indicating one or more motions of the second user, the second character object is excluded from the co-performing video.

11. The system of claim 7, wherein the second character object is excluded from the co-performing video based on co-performer evaluation information indicating an evaluation of the second user from one or more viewer users during distribution of the co-performing video.

12. The system of claim 7, wherein the second character object is excluded from the co-performing video in response to a request from the first user.

13. A method of distributing a video performed by executing computer readable instructions by one or more computer processor, comprising:
in response to reception of a co-performing request from a second user for co-performing with a first user, determining whether to permit the second user co-performing with the first user based on co-performing requester information related to the second user; and
distributing data for causing one or more viewer devices to play a co-performing video in which the first user and the second user co-perform responsive to the second user being permitted to co-perform with the first user.

14. (canceled)

15. The system of claim 1, wherein the one or more computer processors execute computer-readable instructions further to:
in response to reception of another co-performing request from a third user for co-performing with the first user, determine whether to permit the third user co-performing with the first user based on co-performing requester information related to the third user; and
distribute data for causing the one or more viewer user devices to play a video in which the first user and the third user do not co-perform responsive to the third user being not permitted to co-perform with the first user.

16. The system of claim 1, wherein the co-performing video is a character co-performing video including a first character object generated based on one or more motions of the first user and a second character object generated based on one or more motions of the second user.

17. The system of claim 1, wherein the co-performing video is a voice co-performing video including a voice of the second user and a first character object generated based on one or more motions of the first user.

18. The system of claim 1, wherein:
the co-performing video comprises:
a character co-performing video including a first character object generated based on one or more motions of the first user and a second character object generated based on one or more motions of the second user, or
a voice co-performing video including a voice of the second user and a first character object generated based on one or more motions of the first user, and
wherein the character co-performing video and the voice co-performing video are alternately switchable.

19. The system of claim 16, wherein when it is determined that the second character object is in an inactive state in the co-performing video based on motion data indicating one or more motions of the second user, the second character object is excluded from the co-performing video.

20. The system of claim 16, wherein the second character object is excluded from the co-performing video based on co-performer evaluation information indicating an evaluation of the second user from one or more viewer users during distribution of the co-performing video.

21. The system of claim 16, wherein the second character object is excluded from the co-performing video in response to a request from the first user.
